(19) United States
(12) Patent Application Publication
(10) Pub. No.: US 2001/0042382 A1
(43) Pub. Date: Nov. 22, 2001

(54) Arrangement in an air-conditioned system intended for a motor vehicle

(76) Inventor: Bjorn Mardberg, Goteborg (SE)

Correspondence Address: TRACY W. DRUCE, KILPATRICK STOCKTON LLP, 11130 SUNRISE VALLEY DRIVE, SUITE 300, RESTON, VA, 20191-4329, US

(21) Appl. No.: 09/882,643

(22) Filed: Jun. 15, 2001

Related U.S. Application Data
(63) Continuation of application No. PCT/SE99/02338, filed on Dec. 14, 1999.

(30) Foreign Application Priority Data
Dec. 21, 1988 (SE) 9804436-5

(51) Int. Cl. B60H 1/32; F25B 27/00

(52) U.S. Cl. 62/244; 62/323.3

(57) ABSTRACT

The present invention relates to an air conditioning system arrangement intended for motor vehicles, especially passenger cars. The air conditioning system has a compressor, condenser and evaporator that are connected by way of transfer elements in a closed circuit for the transfer of refrigerant. The condenser and evaporator may be arranged on the chassis of the vehicle. The invention compressor may be mounted on the chassis of the vehicle.

### CROSS REFERENCE TO RELATED APPLICATIONS

The present application is a continuation of PCT Application No. PCT/SE99/02338, filed Dec. 14, 1999, which claims priority to Swedish Application No. 980436-5, filed Dec. 21, 1998.

### BACKGROUND OF THE INVENTION

1. Technical Field

The present invention relates to an air conditioning system arrangement intended for motor vehicles, especially passenger cars. The invention has a compressor, a condenser and an evaporator that are connected by transfer elements in a closed circuit for transferring the refrigerant. The condenser and the evaporator are arranged on the chassis of the vehicle.

2. Background Information

U.S. Pat. No. 5,182,922 describes an air conditioning system intended for cars that has a condenser and evaporator fixed to the chassis of the car and a compressor mounted on the car's drive motor. In order to damp vibrations, the drive motor is fixed to the chassis by means of sprung fixing elements. Fluid connection elements are arranged between the compressor and the condenser and between the compressor and the evaporator. The fluid connection elements have rigid pipeline sections in at least three different planes. At least one flexible connecting element is arranged between the pipeline sections. The element is located in an area that is rotatable so that the pipeline sections can move in relation to one another. The portions of the rigid pipelines fluid connection elements are intended to both reduce refrigerant leakage to the surroundings and prevent moisture from getting into the air conditioning system.

### SUMMARY OF THE INVENTION

The present invention seeks to produce an air conditioning system for motor vehicles that represents an improvement over the prior art. This is achieved by means of an air conditioning arrangement having a compressor, condenser and evaporator that connected together in a closed circuit for transfer of the refrigerant. The compressor, the condenser and the evaporator are also preferably mechanically connected to the chassis of the vehicle.

Preferred embodiments may included a compressor that is driven by a motor intended solely for the compressor. The compressor motor may be an electric motor. The compressor motor may be adjustable and designed to control the output of the compressor on the basis of the cooling requirement in the passenger compartment of the vehicle. Other embodiments will be discussed herein below.

The arrangement according to the invention has a number of advantages compared to the prior art. Since the vehicle's drive motor does not have to be used for operation of the compressor, the refrigeration output of the compressor is more freely controllable according to requirements, rather than according to what the drive motor will permit in respect of the number of revolutions. Since the location of the compressor is no longer determined by the position of the drive motor, this increases the scope when choosing the location of the air conditioning system components, such as the compressor, the condenser and the evaporator. With greater freedom of location, the components can be located closer to one another, the pipelines between the components becoming shorter, thereby reducing the risk of leakage. This is advantageous both with regard to the operating costs of the air conditioning system and from an environmental standpoint, since nowadays efforts are being made to reduce or completely eliminate the use of Freons, among other things. The risk of leakage is also reduced in that the pipelines can be made of a rigid material, such as metal or plastic, for example. Due to the fact that the compressor, the condenser and the evaporator are all arranged on the vehicle chassis, shear movements between these components owing to vibrations are reduced. It is therefore less essential that the pipelines be flexible so that the components are somewhat displaceable in relation to one another.

The invention will be explained in more detail below with reference to the FIGURE and with the aid of examples of embodiments of the arrangement according to the invention.

### BRIEF DESCRIPTION OF THE DRAWING

The FIGURE provided illustrates a perspective view of an air conditioning system according to one embodiment of the present invention.

### DETAILED DESCRIPTION OF THE INVENTION

In the FIGURE the reference number 1 denotes an air conditioning system intended for motor vehicles and, in particular, for passenger cars. The air conditioning system 1 is designed to influence the climate in the passenger compartment of the vehicle. The system 1 comprises a condenser 2, an evaporator 3, a drying filter 4 and a compressor 5. The pipelines 6, 7, 8, 9 for transferring refrigerant connect the condenser 2, the evaporator 3, the drying filter 4 and the compressor 5 to form a closed circuit. The pipelines may be jointless. The refrigerant may be a chlorofluorocarbon (“CFC”) refrigerant such as Freon R12, a dichlorodifluoromethane, or hydro-fluorocarbon refrigerant such as R134a, a tetra-fluoroethane, the latter becoming more and more common for environmental reasons.

The pipeline 6 carries liquid refrigerant from the condenser 2 to the evaporator 3. In the evaporator the pressure of the refrigerant is reduced, thereby converting it into a vapor. The refrigerant gas is conveyed via the pipeline 7 to the drying filter 4 and, by way of the pipeline 8, onward to the compressor 5. In the compressor 5 the pressure of the vapor is increased. The vapor thereafter leaves the compressor 5 to be returned via the pipeline 9 to the condenser 2, where the vapor at the same pressure is converted back to a liquid.

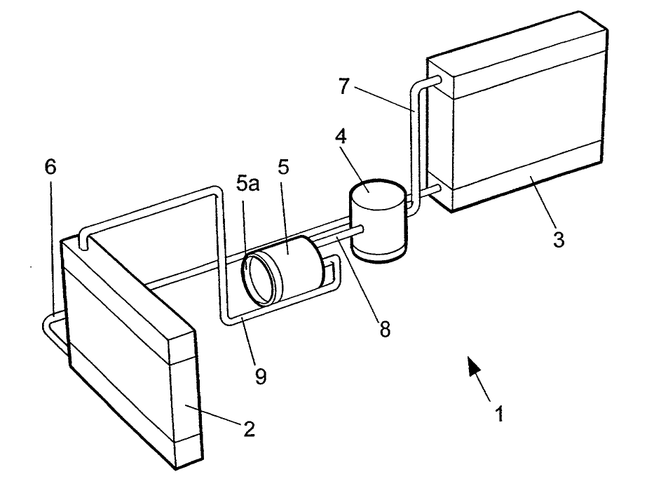

In one embodiment the compressor 5 is driven by a separate compressor motor, for example, an electric motor Sa arranged on the chassis adjacent to the compressor. In another embodiment (not shown) there is a transfer between the compressor and a motor present in the vehicle, for example, the drive motor, wherein the compressor is driven by the motor. The separate motor and the transfer therefore enable the compressor 5 to be separate from the vehicle's drive motor. This increases the number of places where the parts in the air conditioning system may be located. The parts can then be fitted so as to keep the length of the pipelines 6, 7, 8, 9 as short as possible. There is also the option of fitting the parts so that they are as easily accessible as possible, for example, for servicing, or with a view to the weight distribution in the vehicle. In FIG. 1 the compressor 5, the condenser 2, the evaporator 3 and the drying filter 4 may be all fitted to the vehicle chassis. The compressor 5, the evaporator 3 and the drying filter 4 may be fitted along the longitudinal side of the chassis, and the condenser 2 may be fitted next to the vehicle's radiator (not shown).

In one embodiment the compressor and the compressor motor are combined into one unit.

In the passenger compartment controls (not shown) are arranged for controlling the air conditioning system. If the compressor 5 is driven by means of separate motor intended for the compressor, for example, by an electric motor, the compressor motor may be adjustable in order to control its output according to the cooling requirement in the passenger compartment without being restricted by the power output of the vehicle's drive motor. The cooling requirement can be calculated by the air conditioning system on the basis of environmental factors such as the outside temperature and solar radiation, for example, the control settings such as a selected passenger compartment temperature, for example, and the present passenger compartment temperature. If the car motor is a gasoline or diesel engine, conventionally engine speed should limit the output of a compressor fitted to the engine, which is a disadvantage when idling or driving at low revs. On certain car models the problem of the restriction imposed by engine speed has been partially circumvented by incorporating a function into the refrigeration system that acts when required on the engine system so that the idling speed is increased when the air conditioning system is in operation. However, for one skilled in the art, there are a number of disadvantages attached to the increased idling speed.

It is also possible that the compressor motor is fed with drive current from some current source not located adjacent to the actual compressor. For example, the compressor might be fed with current from the vehicle battery or batteries. This is now practically feasible in electric and hybrid cars. Even vehicles with a combined alternator and starter motor, so-called “dynamotors”, could provide the vehicle with sufficient electricity in order to drive the compressor.

Fitting the compressor 5 on the chassis of the vehicle rather than a gasoline or diesel engine means that the compressor 5 is exposed to vibrations with a lower amplitude. Fitting all parts 2, 3, 4, 5 on the chassis reduces the shear forces between the parts due to vibrations. As a consequence, it is less essential that the parts be displaceable in relation to one another. This increases the ability of the parts of the air conditioning system to be substantially rigidly connected to one another by means of the pipelines 6, 7, 8, 9. This, in turn, means that rigid materials can be used as pipelines thereby providing a seal against the leakage of refrigerant out into the surroundings and against moisture getting into the system. If rigid pipelines are used, it may be necessary in certain cases to allow the connecting elements that join these to the parts 2, 3, 4, 5 of the system to have a certain flexibility in order to absorb the vibrations that are produced in the gasoline or diesel-powered engine. Alternatively, the entire system may be mounted on a vibration-damping unit, which is in turn fixed to the chassis of the vehicle.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

What is claimed is:

1. An air conditioning system arrangement intended for motor vehicles comprising:
a compressor,
a condenser, and
an evaporator,
wherein said compressor, condenser and evaporator are connected by way of transfer elements in a closed circuit for the transfer of refrigerant,
wherein said condenser and said evaporator are arranged on the chassis of the vehicle, and
wherein said compressor is mounted on the chassis of the vehicle.

2. The arrangement according to claim 1 wherein the said transfer elements are further comprised of rigid, jointless pipelines made.

3. The arrangement according to claim 1 wherein said compressor, said condenser and said evaporator are located at a short distance from one another.

4. The arrangement according to claim 1 wherein said compressor is driven by means of a motor intended solely for said compressor.

5. The arrangement according to claim 4 wherein said compressor and said compressor motor form a combined unit.

6. The arrangement according to claim 4 wherein said compressor motor is adjustable and designed to control the output of said compressor on the basis of the cooling requirement in the passenger compartment of the vehicle.

7. The arrangement according to claim 4 wherein said compressor motor is an electric motor.

8. The arrangement according to claim 1 wherein said motor vehicle is an electric or hybrid vehicle,
and further wherein said motor driving said compressor is the vehicle drive motor.

9. The arrangement according to claim 2 wherein the pipelines are comprised of plastic.

10. The arrangement according to claim 2 wherein the pipelines are comprised of metal.
